(19) United States
(12) Patent Application Publication
(10) Pub. No.: US 2009/0026850 A1
(43) Pub. Date: Jan. 29, 2009

(54) CYLINDRICAL OSCILLATING FAN

(75) Inventor: Chiao FU, Taichung County (TW)

Correspondence Address: EGBERT LAW OFFICES, 412 MAIN STREET, 7TH FLOOR, HOUSTON, TX, 77002, US

(73) Assignee: KING JIH ENTERPRISE CORP., Tamtzu Hsiang (TW)

(21) Appl. No.: 11/828,278

(22) Filed: Jul. 25, 2007

(51) Int. Cl. H02K 7/00

(52) U.S. Cl. 310/40.5

(57) ABSTRACT

The present invention provides a cylindrical oscillating fan including a base, a cylindrical shell, a blade assembly, a drive motor and an oscillating drive device. The blade assembly and drive motor are assembled into the hollow groove of the cylindrical shell. The oscillating drive device is assembled into the base to drive the oscillation of the cylindrical shell. A support column is placed into the hollow groove. The top end is fastened to the top of cylindrical shell, and the bottom is fastened to the bottom of cylindrical shell. The support column is also screwed onto upper and lower support portions of the base for two-point positioning. The bottom of support column is linked to the oscillating drive device.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a cylindrical oscillating fan structure, and more particularly to an innovative fan with a support column in the cylindrical shell.

2. Description of Related Art Including Information Disclosed Under 37 CFR 1.97 and 37 CFR 1.98.

The so-called cylindrical oscillating fan is generally used for a wide range of industrial applications. It is available with a cylindrical shell for accommodating the fan blade. A base is assembled at the bottom of cylindrical shell to locate a drive device. The relevant case of the cylindrical oscillating fan is demonstrated by Taiwanese patent No. 224310, entitled “An Oscillating Fan Structure”, wherein it can be learnt from FIGS. 4A and 4B that, a support is assembled at the bottom of the cylindrical shell and then linked to the drive device within the base.

However, the following shortcomings are observed during actual applications. Since the cylindrical oscillating fans are widely applied to large-sized industrial products, the focus of shall be put on the structural strength. Owing to the structure that the cylindrical shell is only supported by the cylinder structure, the supporting capacity for the blade assembly and drive motor is insufficient, leading to premature deformation and shorter service life of the cylindrical shell.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based upon an innovation that the cylindrical shell 20 is fitted with a support column 60, the top and bottom 61, 62 of the support column 60 enable the cylindrical shell 20 to be supported strongly, thus avoiding deformation and prolonging the service life with improved durability and applicability.

Since the bottom 62 of the support column 60 is directly driven by the oscillating drive device 50, the loss of driving force could be minimized to ensure a more reliable drive.

As the drive motor 40 and pump 83 are symmetrically arranged at both sides of the support column 60, a steady state of equilibrium could be shaped to provide reliable and low-noise output during oscillation of the entire structure.

When two interlocking arms 53 are driven by two output ends (cranks)for reciprocating rotation with the help of oscillating drive device 50, the assembly portion 57 linked to two interlocking arms 53 and the support column 60 also enable steady and balanced output.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows another exploded perspective view of the preferred embodiment of the present invention.

FIG. 3 shows a partial perspective view of the present invention (cylindrical shell and support column).

FIG. 4 shows a top plan view of the preferred embodiment of the present invention.

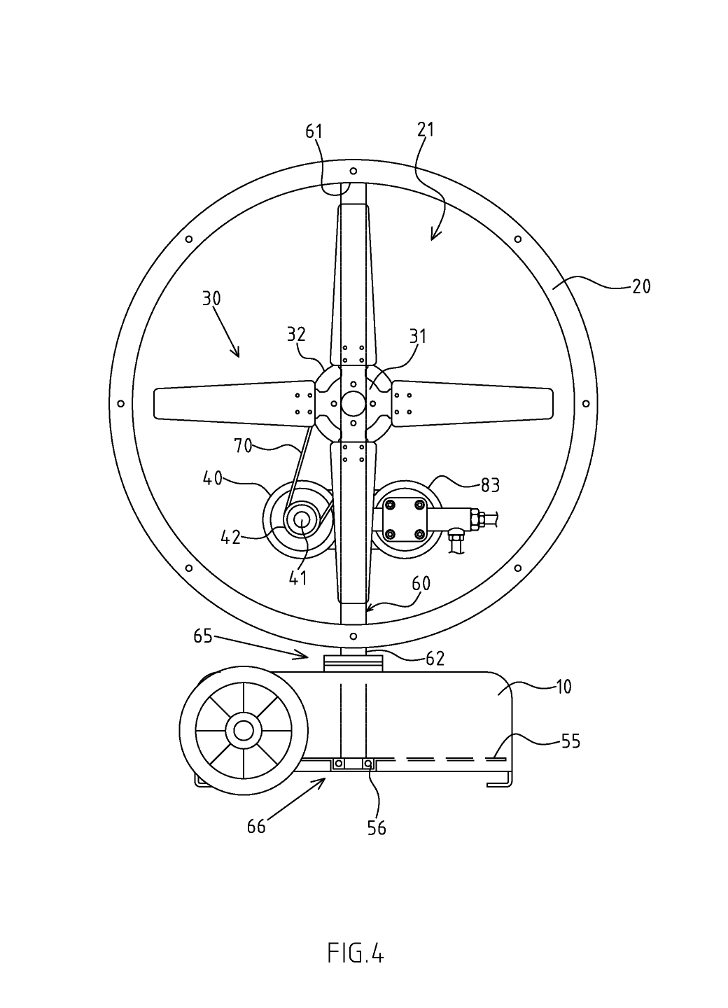

FIG. 5 shows an assembled perspective view of oscillating drive device of the present invention.

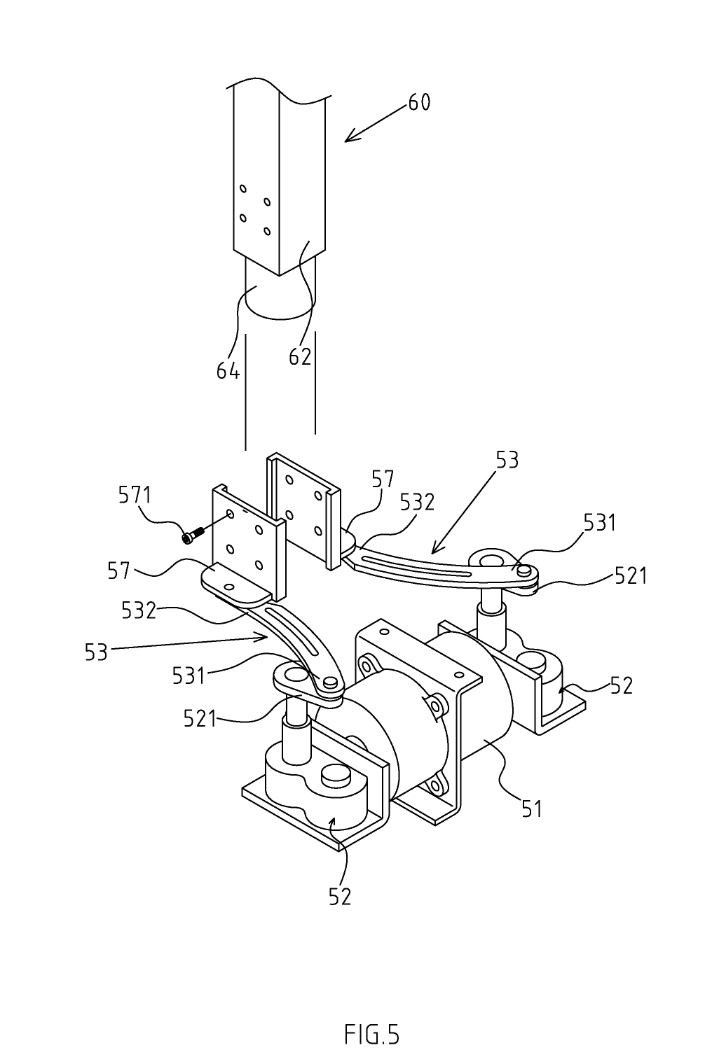

FIG. 6 shows a sectional view of the operation of the oscillating drive device of the present invention.

FIG. 7 shows a top plan view of oscillating drive device of the present invention.

FIG. 8 shows a partial plan view of FIG. 7.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

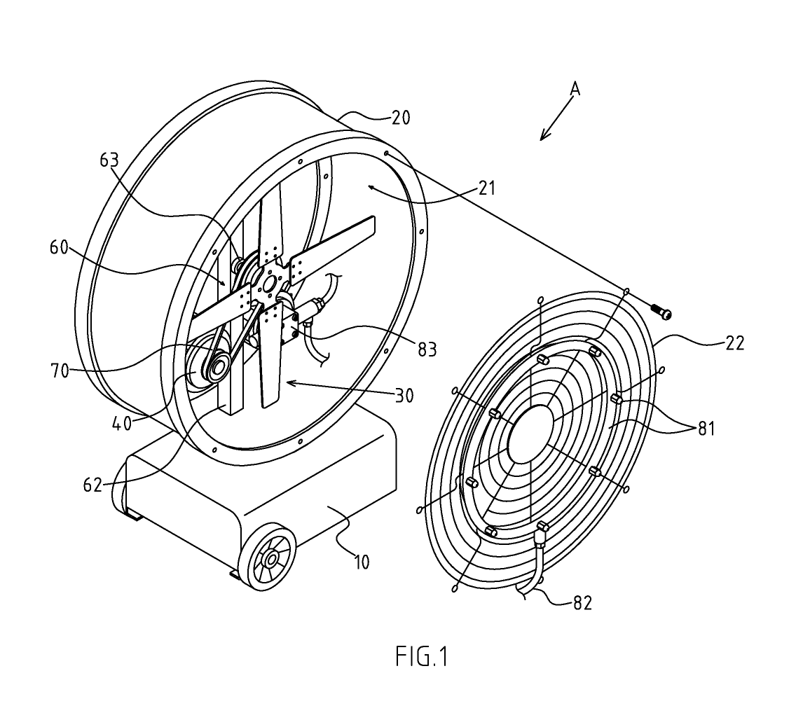

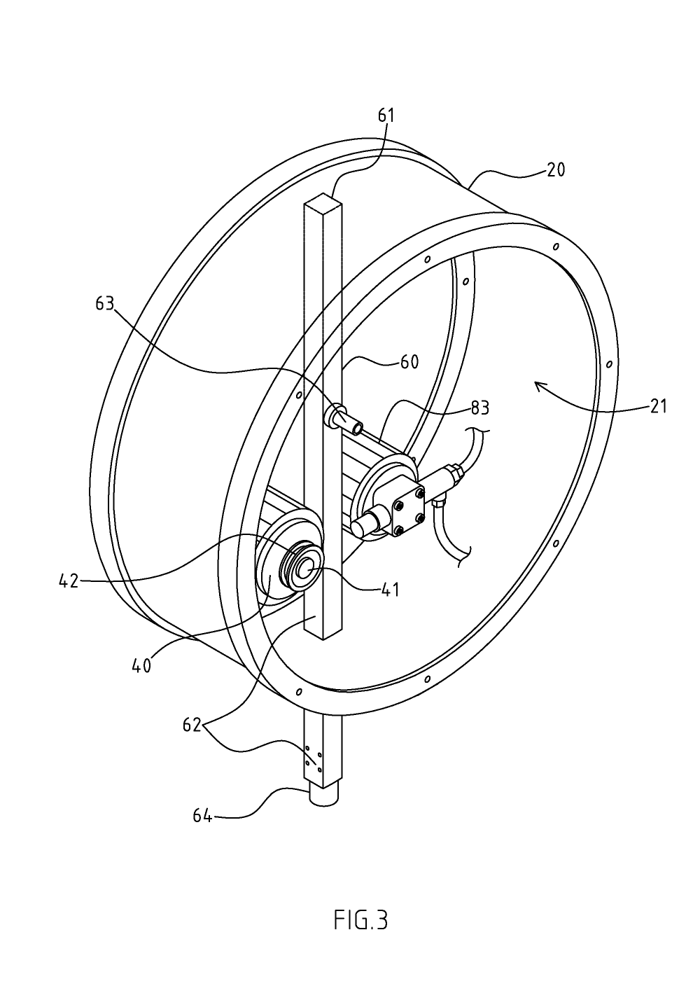

FIGS. 1-3 depict preferred embodiments of cylindrical oscillating fan structure of the present invention. The embodiments are provided only for explanatory purposes. The cylindrical oscillating fan A comprises a base 10, a cylindrical shell 20, a blade assembly 30, a drive motor 40 and an oscillating drive device 50. The blade assembly 30 and drive motor 40 are assembled onto a hollow groove 21 of the cylindrical shell 20. A wire mesh 22 is assembled at a lateral opening of the cylindrical shell 20. The oscillating drive device is assembled into the base 10, so that the cylindrical shell 20 and blade assembly 30 are driven for oscillation at a preset angle.

A support column 60 is placed into the hollow groove 21 of cylindrical shell 20. The top end 61 of support column 60 is fastened (e.g. welded or locked) to the top of cylindrical shell 20. The bottom 62 of support column 60 is fastened (e.g. welded or locked) to the bottom of cylindrical shell 20. The bottom 62 is provided with a protruding end 64, which is screwed onto upper and lower support portion 65, 66 of the base 10 for two-point positioning.

A columella 63 is arranged centrally at the front side of the support column 60 to screw the blade assembly 30. The drive motor 40 is assembled at one side of the support column 60 and spaced from the columella 63. The output axle 41 of the drive motor 40 and central seat 31 of the blade assembly 30 is separately fitted with belt pulley 42, 32 and also connected to them via a belt 70 for driving the blade assembly 30.

The cylindrical oscillating fan A is equipped with a sprinkler 80, which comprises a nozzle set 81, a drainage tube 82 and a pump 83. The nozzle set 81 is externally arranged onto wire mesh 22 of cylindrical shell 20 in a ring pattern. The pump 83 is assembled on the other side of the support column. With the output of drive motor 40, the blade assembly 30 linked to the columella 63 can rotate under the drive of belt 70 on two belt pulleys 32, 42, and water is fed via pump 83 to the drainage tube 82, so that nozzle set 81 can spray water simultaneously with the blade assembly 30.

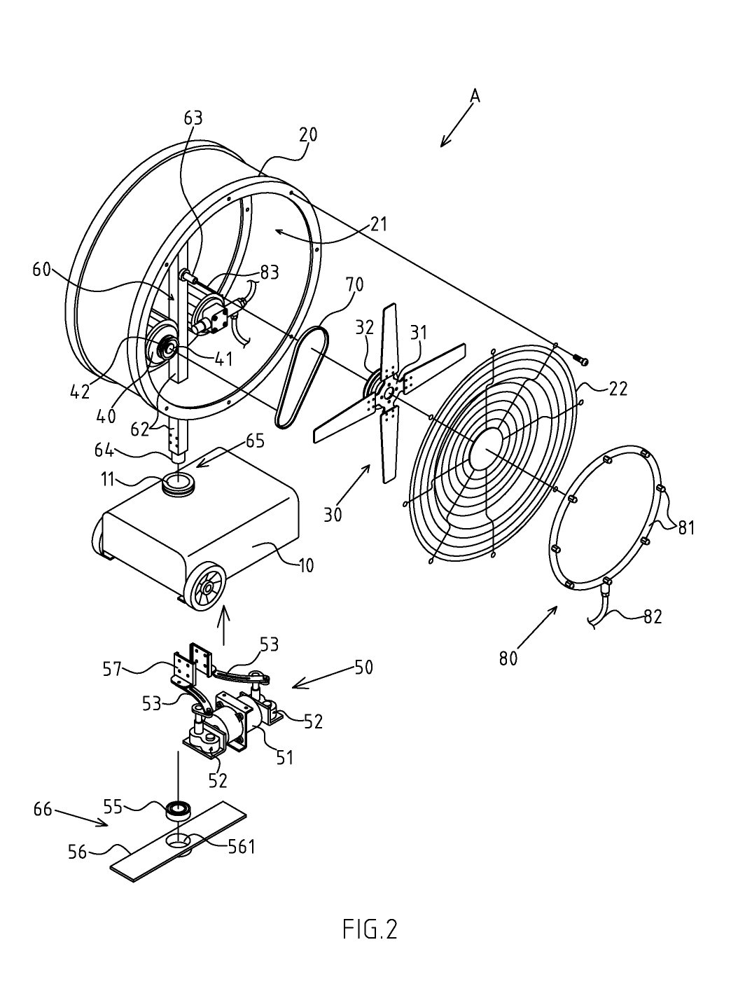

Referring to FIGS. 2,4, and 5, the oscillating drive device 50 comprises a drive motor 51 with two output axles, two gear shift sets 52 and two interlocking arms 53 arranged at intervals. The first end 531 of two interlocking arms 53 is separately linked to output end 521(a crank) of two gear shift sets 52. The second end 532 of two interlocking arms 53 is fitted with an assembly portion 57, which is made of two corresponding iron sheets to fasten securely the bottom 62 of support column 60.

A permanent seat 56 within the base 10 is provided with a coupling hole 561 to assemble a bearing 55. The protruding end 64 assembled onto the bottom 62 extends to the bearing 55, so that the upper and lower support portions 65, 66 are positioned to form an interlocked oscillating drive device 50.

The present invention is operated as follows:

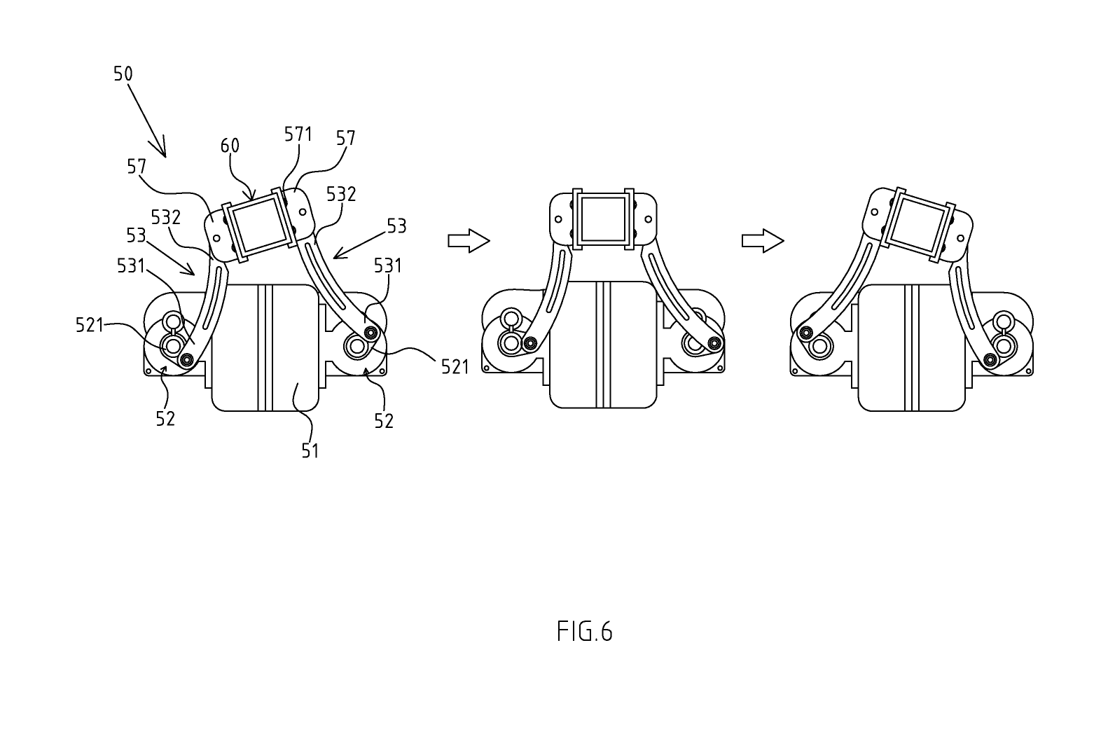

Referring to FIG. 6, two gear shift sets 52 drive the reciprocating rotation of output end 521 (crank) under a two-axle output of drive motor 51 (clockwise rotation in the figure). Meanwhile the interlocking arm 53 linked to the output end 521 also rotates simultaneously to ensure reciprocating oscillation of assembly portion 57 and support column 60.

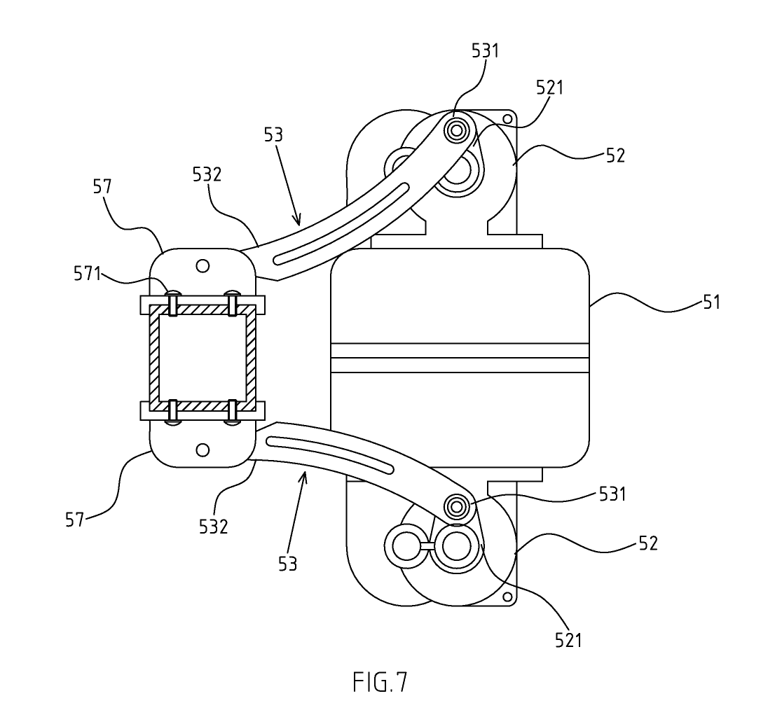

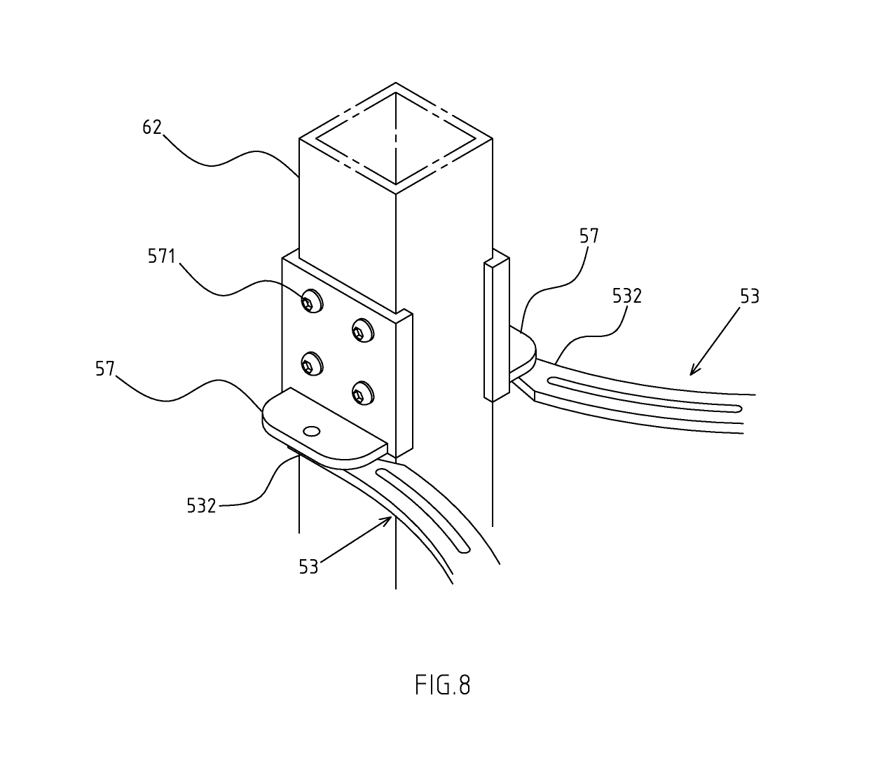

Referring to FIGS. 7 and 8, the interlocking arm 53 is a curved shape. The second end 532 of the interlocking arm 53 is fitted with an assembly portion 57 to fasten securely the bottom 62 of support column 60, while the bottom 62 of support column 60 and the assembly portion 57 are screwed securely by a spacer 571 (bolt).

1. A cylindrical oscillating fan, comprising:
a base, with upper and lower support portions;
a cylindrical shell, being assembled onto said base and provided with a hollow groove, said hollow groove having a wire mesh assembled at a lateral opening of said hollow groove;
a blade assembly and drive motor, assembled into said hollow groove;
an oscillating drive device, assembled into said base, said cylindrical shell having oscillation driven by said oscillating drive device; and
a support column, being assembled into said hollow groove, having a top end fastened to a top of said cylindrical shell, and having a bottom fastened to a bottom of said cylindrical shell, said support column being screwed onto the upper and lower support portions of said base, forming two-point positioning.

2. The fan defined in claim 1, further comprising:
a columella being arranged centrally onto said support column and being in screwing engagement with said blade assembly, said drive motor being assembled at one side of said support column, and spaced from said columella, said drive motor being connected to said blade assembly via a belt.

3. The fan defined in claim 1, further comprising:
a sprinkler, comprising a nozzle set, a drainage tube and a pump, said nozzle set being externally arranged onto said wire mesh of said cylindrical shell in a ring pattern.

4. The fan defined in claim 1, wherein said oscillating drive device comprises a drive motor with two output axles, two gear shift sets and two interlocking arms arranged at interval, a first end of two interlocking arms being separately linked to an output end of two gear shift sets, and a second end of two interlocking arms being coupled with said bottom of said support column via an assembly portion.
